(19) United States
(12) Patent Application Publication
(10) Pub. No.: US 2020/0293785 A1
(43) Pub. Date: Sep. 17, 2020

(54) INFORMATION PROCESSING APPARATUS, INFORMATION PROCESSING METHOD, AND MEDIUM

(71) Applicant: CANON KABUSHIKI KAISHA, Tokyo (JP)

(72) Inventor: Airi Yasui, Kawasaki-shi (JP)

(21) Appl. No.: 16/812,575

(22) Filed: Mar. 9, 2020

(30) Foreign Application Priority Data
Mar. 13, 2019 (JP) 2019-046384

(51) Int. Cl. G06K 9/00; G06F 16/75; G06F 16/783; G06F 16/74

(52) U.S. Cl. CPC G06K 9/00718; G06F 16/74; G06F 16/784; G06F 16/75

(57) ABSTRACT

There is provided with an information processing apparatus. A display control unit causes a display device to display a plurality of detection results of a tracking target sequentially acquired based on images captured by an image capturing unit. The plurality of detection results are displayed in a display style where two or more of the plurality of detection results are grouped in accordance with detection locations of the tracking target and detection times of the tracking target.

### BACKGROUND OF THE INVENTION

### Field of the Invention

The present invention relates to an information processing apparatus, an information processing method, and a medium and particularly to a technique of displaying results of monitoring in a video monitoring system.

### Description of the Related Art

In recent years, large-scale monitoring systems using a plurality of cameras have emerged. As an example of a monitoring system, proposed is a system that detects positions of a tracking target and tracks the tracking target by performing video analysis and recognition processing on a video captured by a camera. In such a system, a previously registered tracking target such as an object or a person is detected by video analysis. Upon the detection of the tracking target, a monitoring person is notified of the detection, and tracking is started. Japanese Patent Laid-Open No. 2018-32994 proposes a system that displays, for a tracking target detected in such a tracking system, a list of thumbnail images acquired from a video of each camera, together with image capture time arranged in a time series. Such a configuration facilitates determining the stay time and the movement path of the tracking target at each location.

### SUMMARY OF THE INVENTION

According to an embodiment of the present invention, an information processing apparatus comprises: an acquisition unit configured to acquire detection locations of a tracking target and detection times of the tracking target; a display control unit configured to cause a display device to display a plurality of detection results of the tracking target sequentially acquired based on images captured by an image capturing unit, wherein the plurality of detection results are displayed in a display style where two or more of the plurality of detection results are grouped in accordance with detection locations of the tracking target and detection times of the tracking target.

According to another embodiment of the present invention, an information processing method comprises: causing a display device to display a plurality of detection results of a tracking target sequentially acquired based on images captured by an image capturing unit, wherein the plurality of detection results are displayed in a display style where two or more of the plurality of detection results are grouped in accordance with detection locations of the tracking target and detection times of the tracking target.

According to still another embodiment of the present invention, a non-transitory computer-readable medium stores a program which, when executed by a computer comprising a processor and a memory, causes the computer to: cause a display device to display a plurality of detection results of a tracking target sequentially acquired based on images captured by an image capturing unit, wherein the plurality of detection results are displayed in a display style where two or more of the plurality of detection results are grouped in accordance with detection locations of the tracking target and detection times of the tracking target.

Further features of the present invention will become apparent from the following description of exemplary embodiments (with reference to the attached drawings).

### BRIEF DESCRIPTION OF THE DRAWINGS

FIG. 1 illustrates an example of hardware configuration of an information processing apparatus according to an embodiment;

FIG. 2 illustrates an example of the functional configuration of an image processing apparatus according to an embodiment;

FIG. 3 is a flowchart of a processing example in an information processing method according to an embodiment;

FIG. 4 is a flowchart illustrating a processing example in grouping processing;

FIG. 5 is a flowchart illustrating a processing example in displaying processing;

FIGS. 6A to 6D illustrate presentation examples of detection information;

FIG. 7 illustrates an example of detection information; and

FIGS. 8A to 8B illustrate examples of group information of a camera and group information of detection information.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

In a case where a tracking target is not moving or the movement speed is slow in a tracking system, the information of the tracking target (e.g., thumbnail image) acquired from a same camera may be successively displayed. For example, in a case where the monitoring area is congested, the tracking target may be obstructed from view by irrelevant people, repeatedly causing a state of the tracking target being detected and a state of the tracking target not being detected. In a case where tracking is started such that the detection of the tracking target is started in the monitoring area and in a case where tracking is terminated such that the tracking target can no longer be detected, the same tracking target is successively detected at the same detection location for a certain time period, and the information of the tracking target is also successively displayed. A similar problem arises in a configuration that displays the information of the tracking target at a predetermined time interval.

A monitoring person, using the tracking system, may occasionally analyze the behavior of a tracking target in order to know “how long the tracking target stayed in a certain location” or “from which location the tracking target moved to which location”. However, there has been a problem that successively displaying information about the same tracking target at the same detection location makes it difficult to determine the stay time and the movement path of the tracking target at each location.

An embodiment of the present invention can make it easier for a user to check the behavior of the tracking target in a tracking system.

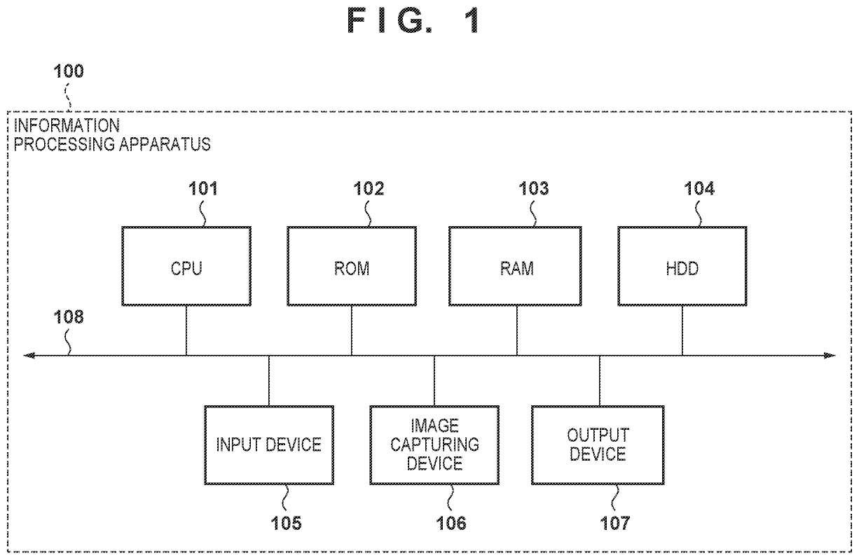

FIG. 1 is a block diagram illustrating an example of a hardware configuration of an information processing apparatus according to an embodiment. An information processing apparatus 100 has a processor, the processor being a CPU 101 (Central Processing Unit) in the example of FIG. 1. The processor can perform arithmetic operations and logical determination for various processes and can control respective components connected to a system bus 108.

The information processing apparatus 100 has a memory including a program memory and a data memory. The program memory stores programs that define controls, which are performed by the processor, including various processing procedures described below. The data memory can provide a loading area and a work area for such a program and also provide a save area for data during error handling. Note that such a program may be loaded on the data memory from an external storage device or the like connected to the information processing apparatus 100. In the example of FIG. 1, the information processing apparatus 100 includes a ROM 102 (Read-Only Memory) as the program memory and a RAM 103 (Random Access Memory) as the data memory.

The information processing apparatus 100 can have a storage medium that stores electronic data, programs, and the like. The storage medium may be a storage device such as a hard disk or an SSD or may be an external storage device. The external storage may be media (recording medium), and the media can be accessed via an external storage drive. As such media, there are known, for example, a flexible disk (FD), a CD-ROM, a DVD, a USB memory, MO, a flash memory, or the like. In addition, the external storage device may be an external information processing apparatus such as a server connected via a network. In the example illustrated in FIG. 1, the information processing apparatus 100 has an HDD 104, which is a hard disk, as a storage medium.

An input device 105 is a device for receiving information indicating an operation made by a user, such as a mouse or a keyboard. An image capturing device 106 is a device for acquiring an image or a video. An output device 107 is a device, such as a display, having a display screen that outputs a presentation to a user. Note that the information processing apparatus 100 may be an information processing system including a plurality of devices, such as a server having the CPU 101, the ROM 102, the RAM 103, and the HDD 104; and also a plurality of the image capturing devices 106.

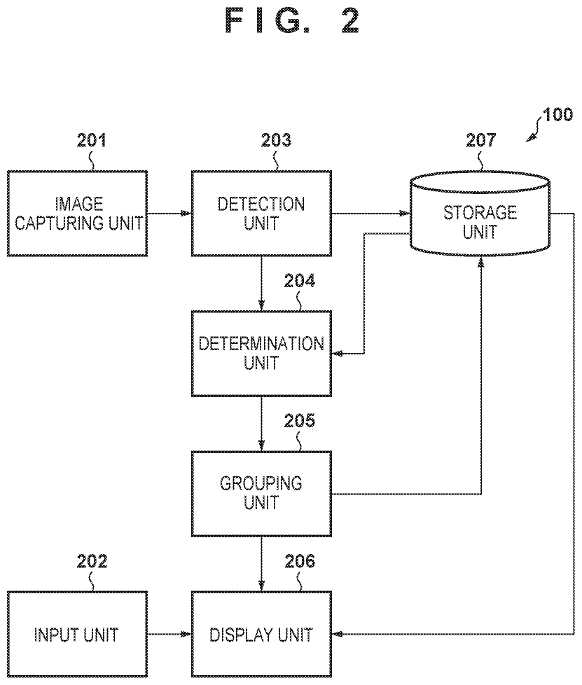

FIG. 2 is a block diagram illustrating an example of the functional configuration of the information processing apparatus according to an embodiment. The information processing apparatus 100 can the cause the display unit to display a plurality of detection results of the tracking target which have been sequentially acquired based on the image captured by the image capturing unit. The information processing apparatus 100 has a determination unit 204, a grouping unit 205, and a display unit 206 as components for performing such display control. In addition, the information processing apparatus 100 may have an image capturing unit 201, an input unit 202, a detection unit 203, and a storage unit 207. Each of the functional units can be realized by the CPU 101 that expands a program stored in the ROM 102 into the RAM 103, and performs a process according to each flowchart described below in accordance with the program. In the aforementioned configuration, the storage unit 207 can be realized by the RAM 103. However, in an embodiment, at least some of the functional units included in the information processing apparatus 100 may be realized by dedicated hardware.

The determination unit 204, the grouping unit 205, and the display unit 206 can perform display control that causes the display unit to display one or more detection results in a display style being grouped in accordance with the detection location of the tracking target and the detection time of the tracking target. In an embodiment illustrated in FIG. 2, the determination unit 204 determines whether or not to treat a detection result as a grouping target. In addition, the grouping unit 205 performs grouping processing on the detection results. Furthermore, the display unit 206 causes the output device 107 to display the detection results in accordance with the results of processing by the grouping unit 205.

Although the type of the tracking target is not particularly limited, the tracking target may be a predetermined subject such as, for example, a specific person. Detection results of such a tracking target can be acquired based on captured images. For example, such detection results can be acquired by performing the detection processing of the tracking target, on each of the sequentially acquired captured images, e.g., on each frame of the video, for example.

The image capturing unit 201 can acquire such a captured image. In the present embodiment, the image capturing unit 201 performs the image capturing of a predetermined area. The image capturing unit 201 is therefore realized by the plurality of image capturing devices 106 each having a different image capturing range. The number of the image capturing devices 106 being used is not particularly limited. In addition, the information processing apparatus 100 may acquire a captured image from an external image capturing device. Hereinafter, the image capturing unit 201 is supposed to acquire a video for a predetermined area formed of a plurality of captured images (frames) successively acquired by each of the image capturing devices 106.

The detection unit 203 can perform the detection processing of the tracking target on a plurality of captured images that are sequentially captured. For example, the detection unit 203 can detect a tracking target appearing in the video captured by performing image analysis processing, for example. In addition, the detection unit 203, when detecting the tracking target, can acquire detection information as a detection result of the tracking target. The detection information refers to information relating to the tracking target. The detection information may include information for identifying the tracking target. As the information for identifying the tracking target, the following are given: identification information of the tracking target, such as an ID or name; and an image of the tracking target (e.g., a thumbnail image extracted from the video image) acquired from the captured image. In addition, the detection information may include information indicating the detection status of the tracking target. As the information indicating the detection status, the following are given: the detection time or the detection location. The detection information may include other information, without being limited to aforementioned information.

In the following example, the detection unit 203 acquires, as the detection information, an image, a detection time, and a detection location of the tracking target. The detection location may be a two-dimensional or three-dimensional position of the tracking target or may be a two-dimensional or three-dimensional position of the image capturing device 106 having captured a video in which the tracking target appears. Furthermore, the detection location may be a name or an ID of the image capturing device 106 having captured a video in which the tracking target appears or may be a name or an ID indicating an area which is a target to be captured by the image capturing device 106. Furthermore, the detection location may be a name or an ID of an image capturing unit group (camera group) to which belongs the image capturing device 106 having captured the video in which the tracking target appears. In this case, for example, the image capturing devices can be grouped such that the plurality of image capturing devices that are intended to take a specific region as a target to be captured are included in a single camera group. Information indicating a camera group to which each of the image capturing devices belongs can be held by the storage unit 207, for example. In addition, the detection time may be the image capture date of an image (or a video frame) in which the tracking target is detected.

In the present embodiment, the detection unit 203 can determine whether or not the tracking target has been detected in each of the videos captured by the image capturing devices 106. Subsequently, when the detection of the tracking target is started in a video captured by one of the image capturing devices 106, the detection unit 203 can store, in the storage unit 207, the detection information of the tracking target acquired from the video by the one of the image capturing devices 106. In this embodiment, the detection information of the tracking target is recorded when the tracking target has entered the image capturing range of one of the image capturing devices 106. On the other hand, in this embodiment, there is a possibility that the detection information of the tracking target is also recorded in a case where an object which had been obstructing the tracking target from view has moved within an image capturing range of one of the image capturing devices 106. Note that the timing of acquiring the detection information is not limited to this example. For example, the detection unit 203 may store, in the storage unit 207, the detection information of the tracking target acquired from a video captured by each of the image capturing devices 106 at a constant time interval. In addition, the detection unit 203 may store, in the storage unit 207, after the tracking target has entered the image capturing range of one of the image capturing devices 106, the detection information of the tracking target acquired from the video by the image capturing device 106 at a predetermined time interval.

In addition, the detection unit 203 can determine whether or not the detection of the tracking target in a video by any of the image capturing devices 106 is started. When the detection of the tracking target is started, the detection unit 203 can notify, via the output device 107, the user that the tracking target has been detected or the tracking of the tracking target is started.

In the present embodiment, the detection unit 203 acquires detection information indicating sequential detection results of the tracking target, based on the image captured by the image capturing unit 201. Subsequently, the display control of such detection results is performed by the determination unit 204, the grouping unit 205, and the display unit 206. In the present embodiment, detection information is displayed on the output device 107 as the detection results. Herein, the detection results may be referred to as detection information. However, the present invention is not limited to such examples. For example, detection processing may be performed such that each of the plurality of image capturing devices acquires a captured image and detects the tracking target in the acquired captured image. In this case, the information processing apparatus 100 can acquire detection information from each of the plurality of image capturing devices. In addition, the information processing apparatus 100 may acquire such detection information from another information processing apparatus such as a server; or from a storage device.

The input unit 202 accepts user input via the input device 105. As user input, the following are given: position input using a mouse pointer or the like; and selection input by clicking or the like.

The storage unit 207 can store detection information acquired by the detection unit 203. In addition, the storage unit 207 may store camera group information indicating a camera group to which each of the image capturing devices belongs. Furthermore, the storage unit 207 may store tracking target information for identifying the tracking target detected by the detection unit 203. The tracking target information may include the image characteristic amount of the tracking target to be used by the detection unit 203 to detect the tracking target, for example. In addition, the tracking target information may include the ID or the name of the tracking target or may include the registration date and time of the tracking target. In the present embodiment, such tracking target information is preliminarily generated and stored in the storage unit 207.

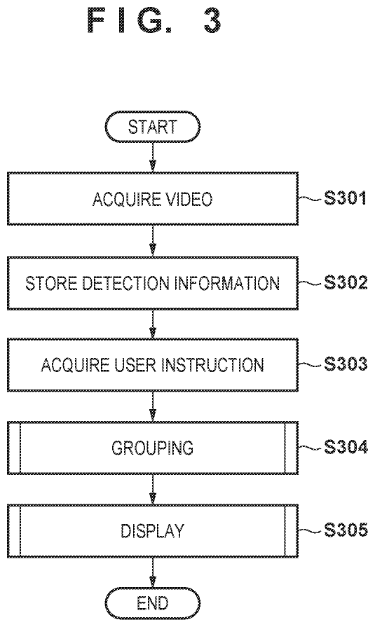

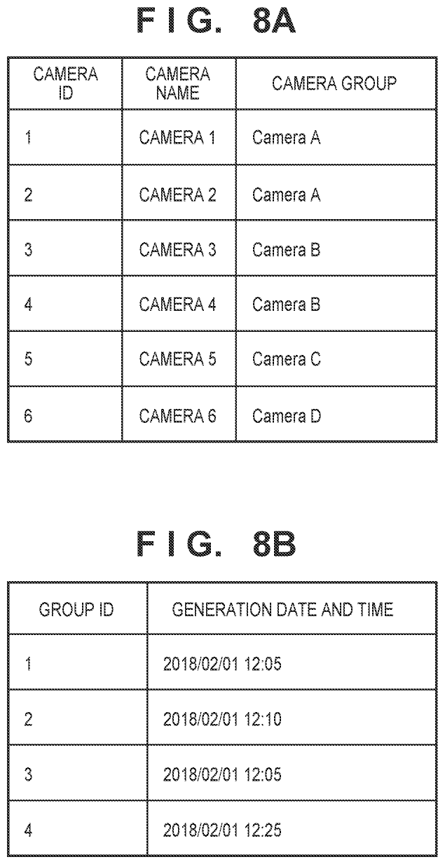

In the following, referring to FIG. 3, described is a flow of an information processing method performed by the information processing apparatus according to the present embodiment. FIG. 3 is a flowchart illustrating an example of processing performed by the information processing apparatus 100. In the present embodiment, the image capturing devices are grouped by each room in which the image capturing devices are installed. An example of camera group information indicating such grouping is illustrated in FIG. 8A. However, the criterion for camera grouping is not limited thereto. In FIG. 8A, image capturing devices having particular camera IDs and camera names are classified into one of camera groups A to D. Additionally, in the present embodiment, the detection information includes, as the detection location, the name of the camera group to which belongs the image capturing device which has detected the tracking target. However, the detection location may be different information, as has been described above.

At step S301, the image capturing unit 201 acquires a live video. Here, the plurality of image capturing devices 106 can simultaneously perform image capturing in each of the image capturing ranges, and the image capturing unit 201 can acquire respective live videos. At step S302, the detection unit 203 detects the tracking target by performing video analysis processing on the videos acquired at step S301. Upon detecting the tracking target, the detection unit 203 stores, in the storage unit 207, the detection information acquired as a result of the video analysis processing.

At step S303, the input unit 202 acquires an operation event indicating a user input. The input unit 202 can acquire, for example, an operation event specifying the display style. In the present embodiment, the display style of grouped detection results is specified by the user. As a specific example, the input unit 202 can detect an operation event that instructs to display only the representative piece of detection information among the grouped detection information; and an operation event that instructs to display all the grouped detection information. Hereinafter, the display style where only the representative piece of detection information is displayed is referred to as a collapsed style, and a display style where all the grouped detection information is displayed is referred to as an expanded style. The input unit 202 stores, in the storage unit 207, the operation events detected in such a manner. However, it is not essential to modify the display style in accordance with user instructions.

At step S304, the determination unit 204 and the grouping unit 205 perform grouping processing on the detection results in accordance with the detection location of the tracking target and the detection time of the tracking target. At step S305, the display unit 206 causes the output device 107 to display one or more detection results in a display style according to the result of the grouping processing at step S304. The processes of steps S304 and S305 are described below.

The detection unit 203 may perform such video analysis processing on a video that lasts for a predetermined time length, i.e., on a plurality of frames, or may perform such video analysis processing on the latest video, i.e., on the latest frame. In the present embodiment, at step S301, the image capturing unit 201 sequentially acquires frames, and at step S302, the detection unit 203 generates a new piece of detection information by performing the detection processing on the tracking target on a newly acquired frame. Subsequently, at step S304, the determination unit 204 and the grouping unit 205 perform a grouping control on the new piece of detection information, and at step S305, the display unit 206 causes the output device 107 to display the newly acquired detection information. In other words, repeating the processes illustrated in FIG. 3 causes the display of the output device 107 to be successively updated. On the other hand, the detection unit 203 may perform the video analysis processing on the video acquired in the past and stored in the storage device.

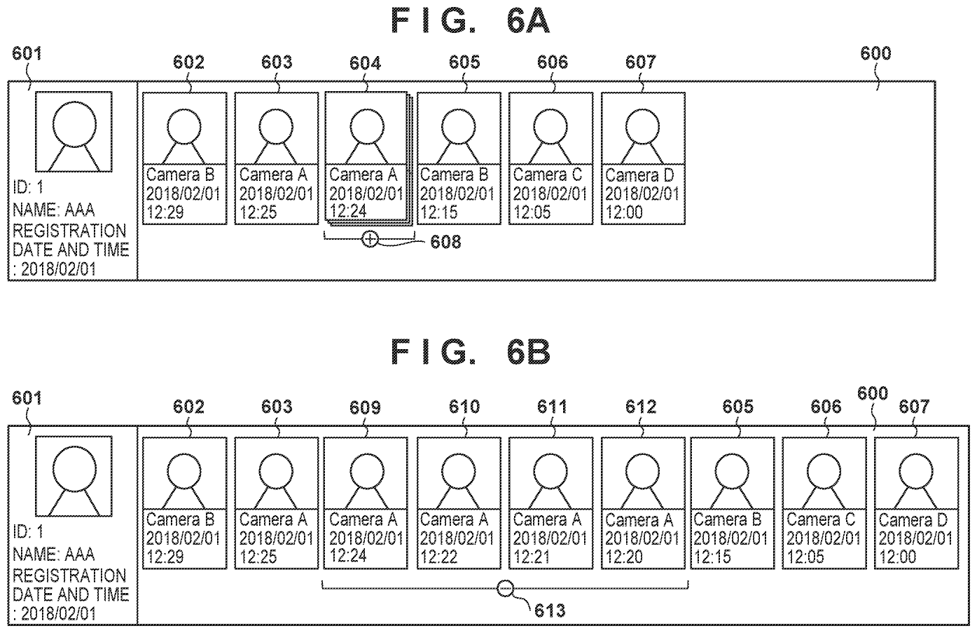

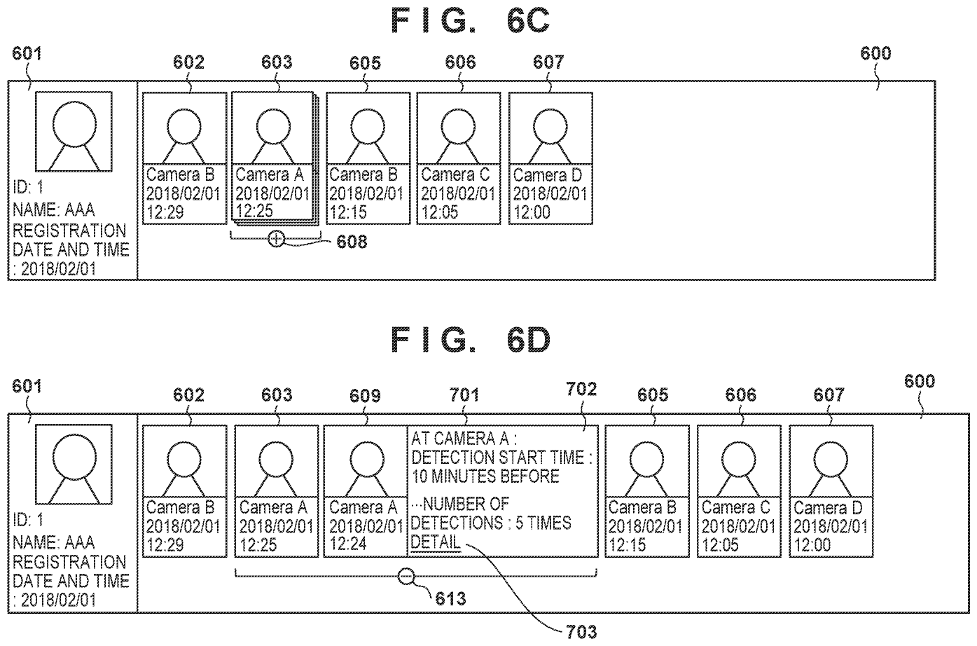

In addition, in a case where there exists a plurality of tracking targets to be tracked by the information processing apparatus 100, the processes of steps S302 to S305 may be performed for each of the tracking targets. In this case, the detection information can be displayed along a time series for each of the tracking targets, similarly to FIGS. 6A to 6D.

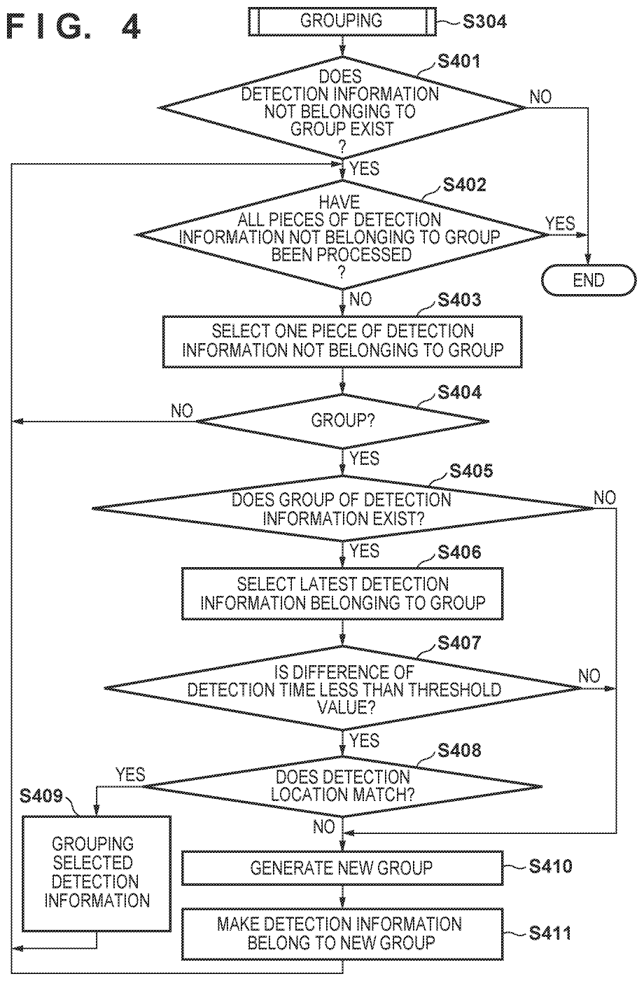

FIG. 4 is a flowchart illustrating an example of the grouping processing at step S304. As described below, the determination unit 204 controls, at step S404, whether or not to group the tracking targets in accordance with the detection time of the tracking targets. In addition, at steps S405 to S411, the grouping unit 205 groups the tracking targets determined by the determination unit 204 as a grouping target, in accordance with the detection locations of the tracking targets. In the following, the process of step S304 is described referring to a specific example.

First, described is a case where the grouping processing of step S304 is performed at 2018 Feb. 1 12:26. At step S401, the determination unit 204 determines whether or not there exists, among the pieces of detection information stored in the storage unit 207, any piece of detection information not belonging to a group. In a case where there exists one or more pieces of detection information not belonging to a group, the process flow proceeds to step S402, otherwise the process flow terminates.

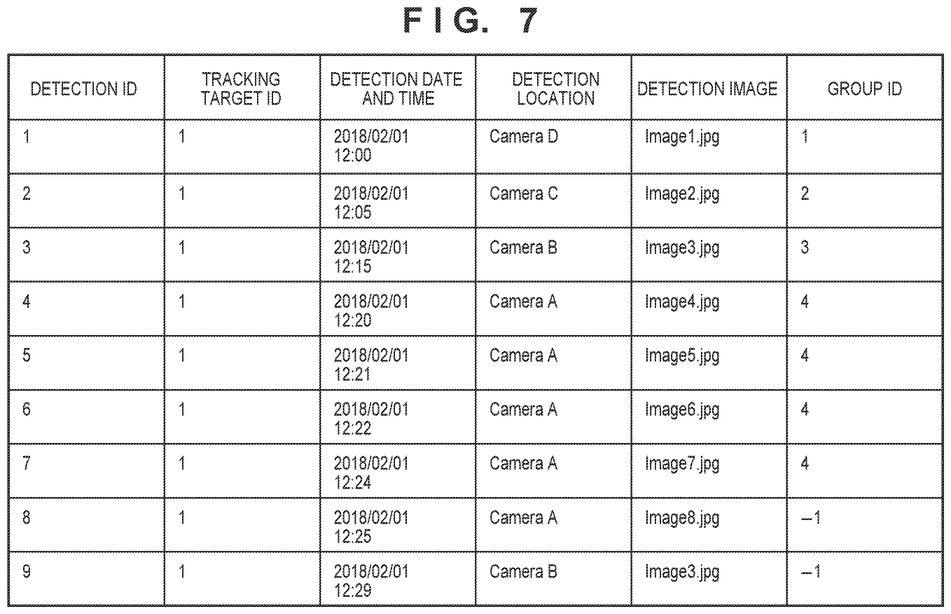

Here, described is a case where the storage unit 207 has stored therein the detection information illustrated in FIG. 7. The detection information illustrated in FIG. 7 includes: the detection ID which is the ID of the detection information; the ID of the tracking target; the detection time of the tracking target; the detection location of the tracking target; the image file name of the detected tracking target; and the group ID which is the ID of the group (detection result group) to which the detection information belongs. In the example of FIG. 7, the detection information includes the group ID in order to associate the detection information and the group information. The storage unit 207 can store group information with regard to such a group of detection information. Although the example of group information illustrated in FIG. 8B indicates the association between respective group IDs and the generation date and time of the group of detection information, the group information in the detection information is not limited to that illustrated in FIG. 8B. Additionally, in the example of FIG. 7, detection information not belonging to a group is provided with “−1” as the group ID.

In this example, the storage unit 207 has stored therein two pieces of detection information (detection IDs 8 and 9) not belonging to a group. Accordingly, the process flow proceeds to step S402.

At step S402, the determination unit 204 determines whether or not the processes at and after step S403 have been performed on all the pieces of detection information not belonging to a group. In a case where the aforementioned processes have been performed, the entire process terminates. In a case where the aforementioned processes have not been performed, the process flow proceeds to step S403. In this example, the processes have not been performed on the two pieces of detection information (detection IDs 8 and 9) and therefore the process flow proceeds to step S403.

At step S403, the determination unit 204 selects a piece of detection information having the oldest detection time, among the pieces of detection information which do not belong to a group and have not been subjected to the processes at and after step S403. In this example, the determination unit 204 selects the piece of detection information having the detection ID 8.

At step S404, the determination unit 204 determines whether or not to select the piece of detection information selected at step S403 as a grouping target, in accordance with the detection time (detection time included in the detection information in the example of FIG. 7) of the tracking target. In the present embodiment, the determination unit 204 performs the aforementioned determination further based on the current time. For example, the determination unit 204 can select the piece of detection information as a grouping target when the difference between the current time and the detection time is equal to or greater than a predetermined threshold value, in which case the process flow proceeds to step S405. On the other hand, the determination unit 204 does not select the piece of detection information as a grouping target when the difference is less than the predetermined threshold value, in which case the process flow returns to step S402. Here, a piece of detection information which has not been selected as a grouping target remain unattached to a group (i.e., group ID=−1).

In this example, the threshold value is set to 5 minutes. The difference between the current time and the detection time of the piece of detection information having the detection ID 8 is less than 5 minutes, and therefore the process flow returns to step S402. Subsequently, at step S403, the determination unit 204 selects a piece of detection information including the detection ID 9. Also in this case, the aforementioned piece of detection information is not selected as a grouping target at step S404. Subsequently, the process flow returns to S402 and processes at and after step S403 are performed on all the pieces of detection information not belonging to a group, and therefore the process flow of FIG. 4 terminates.

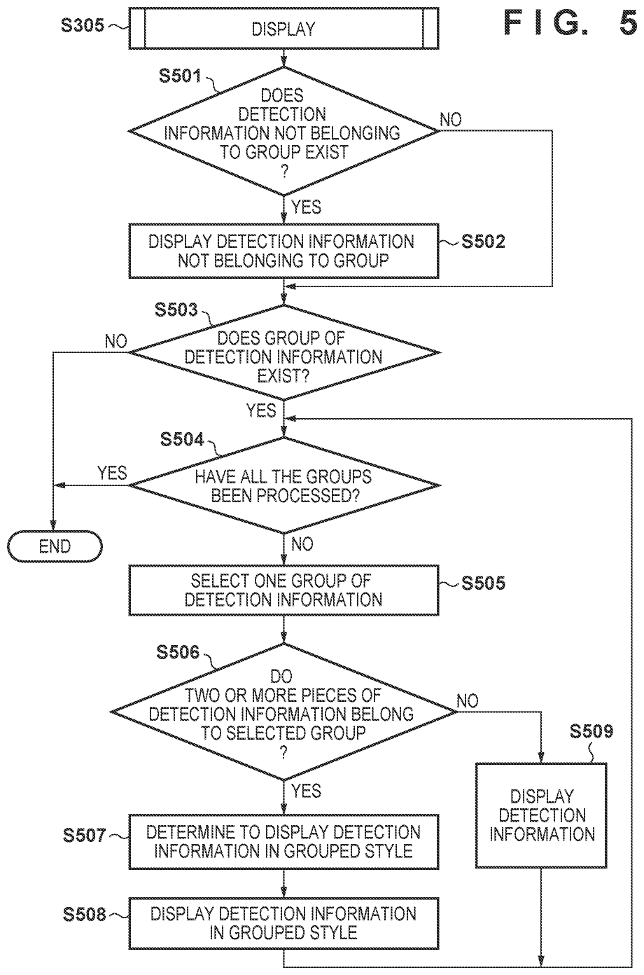

In such an example, the display unit 206 can perform, at step S305, a display control described below. FIG. 5 is a flowchart illustrating an example of the display control processing at step S305. As described below, the display unit 206 causes, at step S305, the output device 107 to display a list of detection results along a time series in the display style according to the result of the grouping processing performed at step S304.

FIGS. 6A to 6D illustrate presentation examples of detection results on the output device 107 in accordance with the display control performed at step S305. In the examples of FIGS. 6A to 6D, pieces of detection information are displayed for each tracking target. In FIG. 6A, the tracking target information is displayed in an area 601. In the example of FIG. 6A, although the ID of the tracking target, the name of the tracking target, and the registration date and time of the tracking target are displayed as the tracking target information, things to be displayed are not limited thereto. In addition, in an area 600, the pieces of detection information for the tracking target indicated in the area 601 are displayed in chronological order.

In the following, the process of step S305 is described referring to a specific example. At step S501, the display unit 206 determines whether or not there exists, among the pieces of detection information stored in the storage unit 207, one or more pieces of detection information not belonging to a group of detection information. In a case where there exists any, the process flow proceeds to step S502, otherwise, the process flow proceeds to step S503. In this example, the storage unit 207 has stored therein two pieces of detection information (detection IDs 8 and 9) not belonging to a group. Accordingly, the process flow proceeds to step S502.

At step S502, the display unit 206 causes the output device 107 to display a list of pieces of detection information not belonging to a group, in a manner arranged in a time series. In an embodiment, the piece of detection information having the latest detection time is displayed on the left end, with pieces of detection information having earlier detection times being displayed rightward. For example, in the example of FIG. 6A, detection information 602 with the detection ID 9 is displayed on the left side and detection information 603 with the detection ID 8 is displayed on the right side.

At step S503, the display unit 206, referring to the group information acquired from the storage unit 207, determines whether or not there exists one or more groups of detection information. In a case where there exists any, the process flow proceeds to step S504, otherwise the process flow of FIG. 5 terminates. In this example, there exist four groups (group IDs 1 to 4) as illustrated in FIG. 8B, and therefore the process flow proceeds to step S504.

At step S504, the display unit 206 determines whether or not the processes at and after step S505 have been performed on all the groups. In a case where the aforementioned processes have been performed, the process flow of FIG. 5 terminates, otherwise the process flow proceeds to step S505. In this example, none of the groups has been processed, and therefore the process flow proceeds to step S505.

At step S505, the display unit 206, referring to the group information acquired from the storage unit 207, selects the group information with the latest generation date and time, among the groups of detection information which have not been subjected to the processes at and after step S505. In the example of FIGS. 6A to 6D, at step S508 or S509, detection information belonging to the group selected at step S505 is displayed on the output device 107. Repeating the processes of step S504 to S509 causes each group to be displayed along a time series in recent order of generation date and time, following the detection information not belonging to the group displayed at step S502. In other words, each group is displayed along a time series in order of the latest detection time of detection information belonging to the group. In this example, the display unit 206 selects a group having the group ID 4.

At step S506, the display unit 206 determines whether or not two or more pieces of detection information belong to the group selected at step S505. In a case where two or more pieces of detection information belong to the group, the process flow proceeds to step S507, or the process flow proceeds to step S509 in a case where one or less piece of detection information belongs thereto. In this example, there exist four pieces of detection information belonging to the group having the group ID 4 (detection IDs 4 to 7), and therefore the process flow proceeds to step S507.

At step S507, the display unit 206 determines to cause the output device 107 to display the detection information belonging to the group selected at step S505 in a grouped display style. In the present embodiment, at subsequent step S508, the display unit 206 acquires, from the storage unit 207, the detection information belonging to the group selected at step S505 and causes the output device 107 to display the information in a display style according to user instructions.

As an example, the display style used by the display unit 206 may include the collapsed style. In the collapsed style, only a part of the plurality of pieces of detection information grouped into one group of detection information are displayed. For example, as illustrated in FIG. 6A, the display unit 206 can cause the output device 107 to display detection information 604 having the detection ID 7 with the latest detection time among the pieces of detection information belonging to a group having the group ID 4. On this occasion, the display unit 206 can control the presentation in a manner recognizable that a plurality of pieces of detection information belong to one group. For example, in a case where two or more pieces of detection information are grouped into one group, the display unit 206 can cause the output device 107 to display the so-grouped detection results in a manner distinguishable from detection results not grouped as such. Specifically, the display unit 206 can cause the output device 107 to display the aforementioned detection information in a style distinguished from detection information not belonging to a group and from detection information not having other detection information belonging to the same group. For example, in FIG. 6A, the detection information 604 displayed in the collapsed style is displayed so that a plurality of pieces of detection information overlap one another. Additionally, in FIG. 6A, the detection information 604 displayed in the collapsed style is provided with an icon 608 indicating that only the representative piece of detection information among the plurality of pieces of detection information is displayed.

As another example, the display style used by the display unit 206 may include the expanded style. In the expanded style, displayed are all the pieces of detection information among the plurality of pieces of detection information grouped in one group of detection information. For example, as illustrated in FIG. 6B, the display unit 206 can cause the output device 107 to display all detection information 609 to 612 (detection IDs 7 to 4) belonging to a group having the group ID 4. Also in the expanded style, the display unit 206 can cause the output device 107 to display the aforementioned detection information in a style distinguished from detection information not belonging to a group and from detection information not having other detection information belonging to the same group. For example, in FIG. 6B, the detection information 609 to 612 displayed in the expanded style is provided with an icon 613 indicating that all the plurality of pieces of detection information are displayed.

The display style on the display unit 206 may be switchable. In other words, the display unit 206 may select one from a plurality of display styles. On this occasion, the display unit 206 may switch the display style based on user instructions. Furthermore, display styles may be individually set for each of the plurality of groups of detection results, and the storage unit 207 may store information indicating a display style for each of the plurality of groups. For example, it is possible to register the information indicating the display style in the group information stored in the storage unit 207.

For example, upon a user clicking on the icon 608 while FIG. 6A is displayed on the output device 107, the input unit 202 detects, at step S303, an operation event specifying the expanded style for the group of detection information having the group ID 4. On this occasion, the storage unit 207 can register, in the group information of the detection information having the group ID 4, information indicating that the expanded style is instructed. At step S508, the display unit 206 can retrieve, from the storage unit 207, such information indicating the display style of the group selected at step S505. Subsequently, the display unit 206 can perform display control such that the group of detection information having the group ID 4 is displayed in the expanded style.

Similarly, upon the user clicking on the icon 613 while FIG. 6B is displayed on the output device 107, the input unit 202 detects an operation event specifying the collapsed style for the group of detection information having the group ID 4. In this case, the display unit 206 can perform, at step S508, display control such that the group of detection information having the group ID 4 is displayed in the collapsed style.

In this example, the process flow returns to S505 through steps S508 to S504. At step S505, the display unit 206 selects a group having the group ID 3 with the latest generation date and time after the group of detection information having the group ID 4. Since only one piece of detection information belongs to the aforementioned group (detection ID 3), the process flow proceeds from step S506 to S509.

At step S509, the display unit 206 acquires, from the storage unit 207, the detection information belonging to the group selected at step S505 and causes the output device 107 to display the detection information. In this example, the display unit 206 causes the output device 107 to display detection information 605 having the detection ID 3. In this example, repeating the processes of step S504 to S509 causes detection information 606 (detection ID 2) belonging to the group having the group ID 2 to be similarly displayed. In addition, detection information 607 (detection ID 1) belonging to a group having the group ID 1 is also displayed.

Next, described is a case where the grouping processing of step S304 is performed again at the time 2018Feb. 1 12:30 after having performed the grouping processing of step S304 at 2018 Feb. 1 12:26. Steps S401 to S403 are performed in a similar manner. At step S404, the difference between the current time and the detection time of the detection information having the detection ID 8 is equal to or greater than 5 minutes, and therefore the process flow proceeds to step S405.

At steps S405 to S411, the pieces of detection information selected at step S403 are grouped. At step S405, the grouping unit 205 determines whether or not there exists one or more groups of detection information. In a case where there exists any, the process flow proceeds to step S406, otherwise the process flow proceeds to step S410. In this example, the group illustrated in FIG. 8B has already been generated, the process flow proceeds to step S406.

At steps S406 to S408, the grouping unit 205 determines whether or not to attach the piece of detection information selected at step S403 to the already generated group of detection information. In the present embodiment, the grouping unit 205 determines whether or not to attach the piece of detection information selected at step S403 to the group containing the latest piece of detection information. Although the determination criterion is not particularly limited, the grouping unit 205 performs determination in the following example in accordance with the detection location of the tracking target indicated by the piece of detection information selected at step S403 and the detection time of the tracking target.

At step S406, the grouping unit 205 selects the latest piece of detection information among the pieces of detection information belonging to the group. For example, the grouping unit 205 can select detection information having a detection time closest to the current time among the pieces of detection information belonging to the group. In this example, a piece of detection information having the detection ID 7 is selected.

At step S407, the grouping unit 205 determines whether or not to group the pieces of detection information in accordance with the detection time of the tracking target indicated by the piece of detection information selected at step S403; and in accordance with the detection time of the tracking target indicated by the piece of detection information selected at step S406. In the present embodiment, the grouping unit 205 determines whether or not the difference between the detection time indicated by the piece of detection information selected at step S406 and the detection time indicated by the piece of detection information selected at step S403 is less than a predetermined threshold value. In a case where the difference is less than the predetermined threshold value, the process flow proceeds to step S408, or the process flow proceeds to step S410 in a case where the difference is equal to or greater than the predetermined threshold value. The predetermined threshold value can be set as appropriate and is set to one hour in this example. In this example, the difference between the detection time indicated by the detection information having the detection ID 7 and the detection time indicated by the detection information having the detection ID 8 is one minute, as illustrated in FIG. 7, and therefore the process flow proceeds to step S408.

At step S408, the grouping unit 205 determines whether or not to group the pieces of detection information in accordance with the detection location of the tracking target indicated by the piece of detection information selected at step S403; and in accordance with the detection location of the tracking target indicated by the piece of detection information selected at step S406. In the present embodiment, the grouping unit 205 determines whether or not the detection location indicated by the piece of detection information selected at step S403 matches the detection location indicated by the piece of detection information selected at step S406. In a case where the locations match, the process flow proceeds to step S409, otherwise the process flow proceeds to step S410.

In the present embodiment, the detection location refers to a camera group to which the image capturing device having detected the tracking target belongs. Accordingly, the grouping unit 205 determines that the detection location matches, in a case where the detection results have been acquired based on images captured by image capturing devices included in the same camera group. According to such a configuration, even in a case where the tracking target is being simultaneously captured by two or more image capturing devices included in the same camera group covering an overlapping image capturing area, it is possible to group the pieces of detection information acquired from images captured by each of the image capturing devices. In this example, as illustrated in FIG. 7, both the detection location indicated by the detection information having the detection ID 7 and the detection location indicated by the detection information having the detection ID 8 correspond to Camera A, and therefore the process flow proceeds to step S409.

At step S409, the grouping unit 205 groups the piece of detection information selected at step S403 with the piece of detection information selected at step S406. In the present embodiment, the grouping unit 205 stores, in the storage unit 207, information indicating the group including the piece of detection information selected at step S403, in a manner of attaching the former piece of information to the group including the detection information selected at step S406. In this example, the grouping unit 205 updates the group ID related to the detection information having the detection ID 8 to the group ID 4, which is the group ID of the group to which the detection information having the detection ID 7 belongs.

In this example, the process flow subsequently returns to step S402 from step S409. Subsequent processes are performed in a similar manner, whereby a piece of detection information having the detection ID 9 is selected at step S403 and it is determined at step S404 that the piece of detection information is to be grouped. At step S406, a piece of detection information having the detection ID 8 is selected. and the process flow proceeds to step S408 through step S407. In this example, the detection location indicated by the detection information having the detection ID 7 corresponds to Camera A, the detection location indicated by the detection information having the detection ID 8 corresponds to Camera B, and therefore the process flow proceeds to step S410 from step S408.

At steps S410 and S411, the grouping unit 205 generates a new group including only the pieces of detection information selected at step S403. In the present embodiment, the grouping unit 205 generates a new group of detection information at step S410. In this example, the grouping unit 205 generates a group having the group ID 5. In addition, the grouping unit 205 stores, in the storage 207, group information which is similar to that of FIG. 8B for the generated group. As described above, it is possible to register the information indicating the display style in the group information. In this example, the display style is either the collapsed style or the expanded style, the initial value being the collapsed style.

At step S411, the grouping unit 205 stores, in the storage unit 207, information indicating the group including the piece of detection information selected at step S403, in a manner attaching the former piece of information to the group generated at step S410. In this example, the grouping unit 205 updates the group ID related to the detection information having the detection ID 9 to the group ID 5, which is the group ID of the newly generated group.

In such an example, at step S305, the display unit 206 can cause the output device 107 to perform the presentation illustrated in FIG. 6C, according to the flowchart of FIG. 5. As illustrated in FIG. 6C, the detection information having the detection ID 8 is included in the group having the group ID 4, and the detection information 603 with the detection ID 8 is displayed in the collapsed style.

According to the present embodiment, in a case where the same tracking target has been detected a plurality of times at the same detection location at or less than a predetermined interval, the detection information is grouped. Such a technique facilitates providing a user with a presentation which is easy to check the behavior of tracking target.

### Modification

The grouping unit 205 according to an embodiment can determine, such as at steps S406 to S408, whether or not to group two or more detection results acquired at successive detection times. In the above example, two detection results are grouped in a case where the difference between the detection times is less than a threshold value (S407) and the detection locations match (S408). However, the method for determining whether or not to group is not limited to such an example.

In an embodiment, the grouping unit 205 can determine whether or not to group two or more detection results obtained at successive detection times, in accordance with the detection location of the tracking target. In particular, the grouping unit 205 may determine whether or not to group two or more detection results in accordance with whether or not the detection locations match. According to such a configuration, it is possible to group the detection information of the tracking target detected at the same or close detection location, whereby it becomes easier to check the behavior of the tracking target. Accordingly, it is not essential to consider the difference between the detection times when performing grouping in accordance with the detection location of the tracking target and the detection time of the tracking target.

The display style is not limited to those described above. For example, as a display style, there may be displayed only two or more pieces of detection information which are a part of a plurality of pieces of detection information belonging to one group. In addition, as another display style, there may be displayed a summary of a plurality of pieces of detection information belonging to one group. As a specific example, the following are given: information common to a plurality of pieces of detection information, information selected from mutually different pieces of detection information, information acquired by analysis of a plurality of pieces of detection information, and information calculated from a plurality of pieces of detection information and being different from items included in the detection information.

FIG. 6D illustrates one of such examples. In FIG. 6D, an area 701 is a presentation example of a group having the group ID 4 in the expanded style. In the area 701, there are displayed the detection information 603 having the detection ID 8 and the detection information 609 having the detection ID 7. In addition, as illustrated in FIG. 6D, further displayed is summary information 702 related to the detection information belonging to the group having the group ID 4. The summary information 702 includes the detection location (common to each detection information), the detection start time (i.e., the detection time indicated by the detection information having the oldest detection ID 4), and the number of detections (the number of pieces of detection information). Accordingly, detailed information about old detection information may be omitted and a summary may instead be displayed, while displaying detailed information about new detection information. In addition, a link 703 for referencing detailed information about old detection information may be displayed. For example, a click on the 703 by a user displays all the pieces of detection information belonging to a group. Note that FIG. 6D is merely an example and the method for displaying a summary is not limited thereto.

The aforementioned example displays, in the collapsed style, detection information with the latest detection time among the pieces of detection information belonging to the group. However, the detection information to be displayed may be selected based on another criterion, or a summary such as described above for a plurality of pieces of detection information belonging to a group may be displayed instead of the detection information. As an example, detection information selected based on the recognition reliability of the tracking target acquired during video analysis may be displayed.

Additionally, in the above example, whether or not to treat a piece of detection information as a grouping target is determined in accordance with the difference between the current time and the detection time. However, the method for determining a grouping target is not limited to the aforementioned method. In an embodiment, the determination unit 204 determines whether or not to treat a piece of detection information as a grouping target, further based on a later detection result than the aforementioned detection result. For example, the determination unit 204 may determine whether or not to treat a piece of detection information as a grouping target, based on another piece of detection information not yet belonging to a group.

As a specific example, the determination unit 204 can perform the aforementioned determination based on the detection location indicated by the piece of detection information selected at step S403; and based on the detection location indicated by a piece of detection information whose detection time is later than that of the former piece of detection information. For example, the determination unit 204 can determine, as a grouping target, the piece of detection information selected at step S403 regardless of the detection time, in a case where the detection locations do not match. For example, the detection location indicated by the detection information having the detection ID 8 does not match the detection location indicated by the detection information having the detection ID 9. Therefore, in a case having selected at step S403 the detection information having the detection ID 8, the determination unit 204 can determine, as a grouping target, the piece of detection information having the detection ID 8.

As another specific example, the determination unit 204 can perform the aforementioned determination based on the detection time indicated by the piece of detection information selected at step S403; and based on the detection time indicated by the detection information whose detection time is later than that of the former piece of detection information. For example, the determination unit 204 can determine, as a grouping target, the piece of detection information selected at step S403 regardless of the current time, in a case where there exists a piece of detection information whose detection time is later than the detection time of the piece of detection information selected at step S403. According to such a configuration, there is a possibility that only the latest piece of detection information is excluded from the grouping targets, and all the other pieces of detection information turn out to be grouping targets.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-046384, filed Mar. 13, 2019 which is hereby incorporated by reference herein in its entirety.

What is claimed is:

1. An information processing apparatus comprising:
an acquisition unit configured to acquire detection locations of a tracking target and detection times of the tracking target;
a display control unit configured to cause a display device to display a plurality of detection results of the tracking target sequentially acquired based on images captured by an image capturing unit, wherein
the plurality of detection results are displayed in a display style where two or more of the plurality of detection results are grouped in accordance with detection locations of the tracking target and detection times of the tracking target.

2. The information processing apparatus according to claim 1, wherein the display control unit is further configured to determine whether or not to group two or more detection results acquired at successive detection times, in accordance with the detection locations of the tracking target.

3. The information processing apparatus according to claim 2, wherein the display control unit is further configured to determine whether or not to group the two or more detection results, in accordance with whether or not the detection locations match.

4. The information processing apparatus according to claim 3, wherein the display control unit is further configured to determine that the detection locations match, in a case where the two or more detection results have been acquired based on images captured by image capturing units included in the same image capturing unit group.

5. The information processing apparatus according to claim 4, wherein the display control unit is further configured to determine whether or not to group the two or more detection results, in accordance with a difference between the detection times.

6. The information processing apparatus according to claim 1, wherein the display control unit is further configured to determine whether or not to treat a detection result as a grouping target, in accordance with current time and the detection time of the tracking target.

7. The information processing apparatus according to claim 6, wherein the display control unit is further configured to determine whether or not to treat the detection result as a grouping target, based on a later detection result than the detection result.

8. The information processing apparatus according to claim 1, wherein the display control unit is further configured to cause the display device to display only a part of the detection results that are grouped.

9. The information processing apparatus according to claim 1, wherein the display style is selected from display styles including:
a collapsed style where only a part of the detection results that are grouped are displayed and
an expanded style where all of the detection results that are grouped are displayed,
and the display control unit is further configured to switch display styles.

10. The information processing apparatus according to claim 1, wherein the display control unit is further configured to change the display style based on user instruction.

11. The information processing apparatus according to claim 1, wherein the display style is set individually for each of a plurality of detection result groups.

12. The information processing apparatus according to claim 1, wherein the detection results respectively include images of the tracking target acquired from the images that are captured.

13. The information processing apparatus according to claim 1, wherein the display control unit is further configured to cause the display device to display detection results which are grouped in a manner distinguishable from the detection results which are not grouped.

14. The information processing apparatus according to claim 1, further comprising a detection unit configured to generate the detection results by performing detection processing of the tracking target on a plurality of the images that are sequentially captured.

15. The information processing apparatus according to claim 1, further comprising the image capturing unit configured to capture the images.

16. An information processing method comprising:
causing a display device to display a plurality of detection results of a tracking target sequentially acquired based on images captured by an image capturing unit, wherein
the plurality of detection results are displayed in a display style where two or more of the plurality of detection results are grouped in accordance with detection locations of the tracking target and detection times of the tracking target.

17. A non-transitory computer-readable medium storing a program which, when executed by a computer comprising a processor and a memory, causes the computer to:
cause a display device to display a plurality of detection results of a tracking target sequentially acquired based on images captured by an image capturing unit, wherein
the plurality of detection results are displayed in a display style where two or more of the plurality of detection results are grouped in accordance with detection locations of the tracking target and detection times of the tracking target.
